(19) United States
(12) Patent Application Publication
(10) Pub. No.: US 2026/0028504 A1
(43) Pub. Date: Jan. 29, 2026

(54) HIGH-VOLTAGE WILDLIFE MITIGATION COVERS

(71) Applicant: Aclara Technologies LLC, St. Louis, MO (US)

(72) Inventors: Nejib Masghouni, Alpharetta, GA (US); Cauley Sean Price, Atlanta, GA (US); Jennifer Emily Mays, Edmonton (CA); Irineo Cruz Valenzuela, Edmonton (CA); Alton Darren Barnett, Little Rock, AR (US)

(21) Appl. No.: 19/278,198

(22) Filed: Jul. 23, 2025

Related U.S. Application Data
(60) Provisional application No. 63/674,430, filed on Jul. 23, 2024.

(51) Int. Cl. C09D 175/02; C09D 7/61; C09D 7/63

(52) U.S. Cl. CPC C09D 175/02; C09D 7/61; C09D 7/63

(57) ABSTRACT

Disclosed herein are wildlife mitigation covers for protecting high-voltage components, e.g., in electrical power distribution systems, that have improved stability and performance. An example cover includes a polyurea and a silicone. Also disclosed herein are methods of making the cover and high-voltage assemblies including the cover.

### CROSS-REFERENCE TO RELATED APPLICATIONS

This application claims priority to U.S. Provisional Patent Application No. 63/674,430 filed on Jul. 23, 2024, which is incorporated fully herein by reference.

### TECHNICAL FIELD

This disclosure relates to covers for protecting high-voltage components from, e.g., wildlife.

### INTRODUCTION

Wildlife can create serious power disruptions when they short circuit high-voltage power equipment, such as electrical switches, insulators, and bushings. The damage can disable the distribution and substation equipment used to supply electrical energy to communities. Solutions to prevent animals from approaching power equipment, such as the use of chemical pesticides, are expensive, not environmentally friendly, and must be repeatedly applied. In addition, current materials for wildlife mitigation in high-voltage applications lack properties that can ensure long-lasting, high-performing protection. Accordingly, new and improved materials can be useful in overcoming or limiting these issues.

### SUMMARY

In one aspect, disclosed herein are covers for protecting a high-voltage component from wildlife, the cover including: a polyurea; and a silicone.

In another aspect, disclosed herein are covers for protecting a high-voltage component from wildlife, the cover including, by weight: about 70% polyurea, wherein the polyurea is derived from equal parts of an amine and an isocyanate; about 5% polydimethylsiloxane (PDMS) oil; about 9.5% alumina trihydrate; and about 0.5% tinuvin.

In another aspect, disclosed herein are high-voltage assemblies including: a component capable of operating in a high-voltage environment; and a cover at least partially enclosing the component, the cover including a polyurea, and a silicone.

In another aspect, disclosed herein are methods of making a cover for protecting a high-voltage component from wildlife, the method including: mixing a silicone with an amine, an isocyanate, or both; and spraying the silicone, the amine, and the isocyanate onto a mold to provide the cover.

### BRIEF DESCRIPTION OF THE DRAWINGS

FIG. 1 shows an example application of a wildlife mitigation cover.

FIG. 2 shows example applications of wildlife mitigation covers.

### DETAILED DESCRIPTION

Disclosed herein are materials that can achieve improved performance and stability for mitigating wildlife interactions with high-voltage components. The disclosed materials can balance the mechanical, chemical stability, and moisture impermeability properties of polyurea with ultraviolet (UV) protection and enhanced tracking and erosion performance of silicone. In addition, the disclosed materials can be made by spray coating, rather than requiring injection molding methods. The disclosed materials can therefore be used as covers to mitigate wildlife incursions of high-voltage components and assemblies thereof.

### 1. DEFINITIONS

Unless otherwise defined, all technical and scientific terms used herein have the same meaning as commonly understood by one of ordinary skill in the art. In case of conflict, the present document, including definitions, will control. The materials, methods, and examples disclosed herein are illustrative only and not intended to be limiting. Methods and materials similar or equivalent to those described herein can be used in practice or testing of the disclosed technology. All publications, patent applications, patents and other references mentioned herein are incorporated by reference in their entirety.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The terms “mounted,” “connected,” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated, and for the range 1.5-2, the numbers 1.5, 1.6, 1.7, 1.8, 1.9, and 2 are contemplated.

### 2. COVERS FOR PROTECTING HIGH-VOLTAGE COMPONENTS FROM WILDLIFE

Disclosed herein are covers that can mitigate wildlife interactions with high-voltage components. This can be beneficial for limiting disruption of electrical power distribution systems due to environmental factors. The cover includes at least two different materials: a polyurea and a silicone. By using these two materials, the disclosed covers can balance beneficial properties of each individual material, while limiting the disadvantages of each. Overall, this can improve the stability and performance of the disclosed covers compared to those presently used.

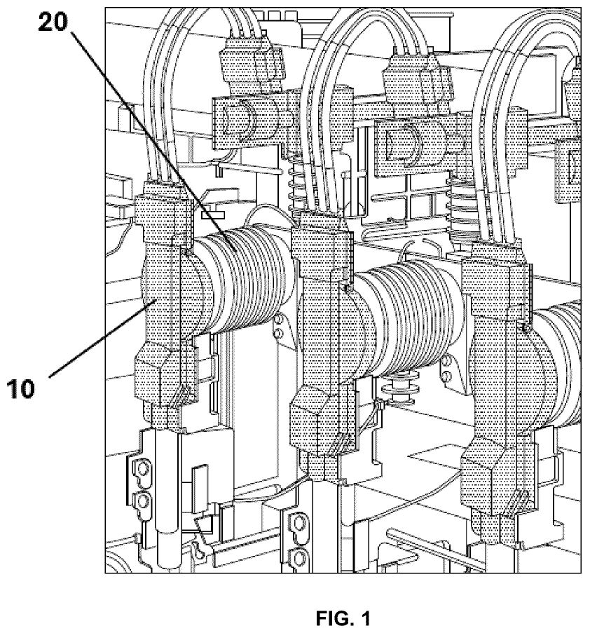

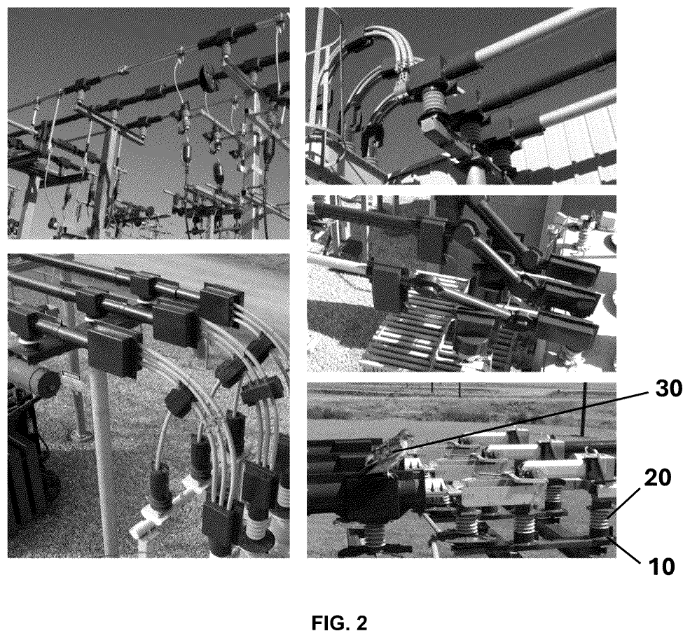

The cover can be used to protect any type of high-voltage component, e.g., that can be used in electrical power transmission and distribution systems. For example, the high-voltage component can be an energized component in an electrical power distribution system. Example components include, but are not limited to, transformers, breakers, regulators, reactors, enclosed switchgear, capacitors, disconnect switches, cutouts, bus conductor, stranded conductor, insulators, bushings, support structures, grounded structures, mounting structures, gang operated switches, instrument transformers, lightning arresters, reclosers, tap connectors, splice connectors, connection terminals, equipment drive arms, expansion joints, vacuum switches, equipment attachment brackets, gas switches, terminators, deadends, fuses, crossarms, and poles. An example application can be seen in FIG. 1. In the illustrated embodiment, the cover 10 (shaded) protects a high-voltage component 20 that is a bushing. FIG. 2 shows further example applications of different covers 10 protecting high-voltage components 20 from wildlife 30.

In some embodiments, the high-voltage component is an arrester, a transmission and distributor insulator, a polymer cut-out, a fusing, a bushing, or an interrupter. A high-voltage arrester is a protective device for limiting voltage on equipment by discharging or bypassing surge current. A high-voltage insulator is a device used to isolate the electrical conductors from the tower on the ground. A fuse cutout is a device used to protect distribution transformers from current surges and overloads.

The high-voltage component is capable of operating in environments with varying high-voltages. High-voltage components can be graded or rated to operate in a particular high-voltage environment, which is typically provided by the supplier. For example, the component can be capable of operating in an environment (or rated for a voltage) of about 1 kV to about 765 kV, such as about 10 kV to about 765 kV, about 20 kV to about 765 kV, about 50 kV to about 765 kV, about 75 kV to about 765 kV, about 100 kV to about 765 kV, about 200 kV to about 765 kV, about 300 kV to about 765 kV, about 500 kV to about 765 kV, about 1 kV to about 50 kV, about 1 kV to about 500 kV, about 10 kV to about 500 kV, or about 100 kV to about 600 kV. In some embodiments, the component is capable of operating in an environment with a voltage of greater than 1 kV, greater than 10 kV, greater than 50 kV, greater than 75 kV, greater than 100 kV, greater than 150 kV, greater than 200 kV, greater than 250 kV, greater than 300 kV, greater than 350 kV, greater than 400 kV, greater than 450 kV, or greater than 500 kV. In some embodiments, the component is capable of operating in an environment with a voltage of less than 800 kV, less than 775 kV, less than 765 kV, less than 750 kV, or less than 700 kV. In some embodiments, the high-voltage component is capable of operating in an environment or rated for a voltage of up to 70 kV.

The shape of the cover is generally not limited and can take the shape or aspect thereof of the high-voltage component it is covering and/or protecting. For example, the cover can be molded to the shape of the high-voltage component. As such, the cover can take the shape of a high-voltage component or an aspect of the high-voltage component. The cover can enclose the high-voltage component such that it is secure and can withstand environmental elements. In some embodiments, the cover is secured to the high-voltage component through fasteners. An example fastener includes a push fastener, but any type of fastener in the art can be used. In some embodiments, the cover partially encloses the high-voltage component. In other embodiments, the cover fully encloses the high-voltage component.

The balance between the polyurea and the silicone can provide advantageous properties for protecting high-voltage components. These properties can include, but are not limited to, improved electrical and mechanical performance, as well as stability. For example, the cover can have a dielectric strength of at least 450 V/mil, at least 500 V/mil, at least 550 V/mil, at least 600 V/mil, at least 650 V/mil, at least 700 V/mil, at least 800 V/mil, at least 900 V/mil, or at least 1,000 V/mil. In some embodiments, the cover has a dielectric strength of about 450 V/mil to about 1,000 V/mil, such as about 500 V/mil to about 900 V/mil, about 600 V/mil to about 800 V/mil, about 450 V/mil to about 700 V/mil, or about 600 V/mil to about 1,000 V/mil. Dielectric strength can be measured according to the standard ASTM D149 or ASTM D450.

The cover can have beneficial tracking and erosion resistance properties. For example, the cover can have an inclined plane tracking resistance of at least 3 kV, at least 3.5 kV, at least 4 kV, at least 4.5 kV, at least 5 kV, at least 5.5 kV, or at least 6 kV. In some embodiments, the cover has an inclined plane tracking resistance of about 3 kV to about 7 kV, such as about 3.2 kV to about 6.8 kV, about 3.5 kV to about 6 kV, about 3 kV to about 5 kV, or about 4.5 kV to about 7 kV. Inclined plane tracking resistance can be measured according to the standard ASTM D2303.

The cover can have a tensile strength of at least 13.8 MPa (˜2,000 PSI), at least 14 MPa, at least 15 MPa, at least 16 MPa, at least 17 MPa, at least 18 MPa, at least 19 MPa, at least 20 MPa, at least 21 MPa, at least 22 MPa, at least 23 MPa, at least 24 MPa, at least 25 MPa, at least 26 MPa, at least 27 MPa, or at least 28 MPa. In some embodiments, the cover has a tensile strength of about 13.8 MPa to about 28 MPa, such as about 14 MPa to about 26 MPa, about 15 MPa to about 25 MPa, about 13.8 MPa to about 22 MPa, about 13.8 MPa to about 18 MPa, about 18 MPa to about 28 MPa, or about 20 MPa to about 28 MPa. Tensile strength can be measured by the standard ASTM D412.

The cover can have an advantageous ultraviolet stability. For example, the cover can have a UV stability of at least 1,000 hours, at least 1,200 hours, at least 1,400 hours, at least 1,600 hours, at least 1,800 hours, at least 2,000 hours, at least 2,200 hours, at least 2,400 hours, at least 2,600 hours, at least 2,800 hours, or at least 3,000 hours. In some embodiments, the cover has a UV stability of about 1,000 hours to about 3,000 hours, such as about 1,200 hours to about 2,800 hours, about 1,500 hours to about 2,500 hours, about 1,000 hours to about 2,000 hours, or about 2,000 hours to about 3,000 hours. UV stability can be measured by standard ASTM D4329.

The cover can also have useful flammability properties. For example, the cover can have a UL-94 standard: V-0 rating. The UL 94 V-0 rating is a flammability standard for plastics, indicating a high level of flame retardancy. Materials with a rating of V-0 self-extinguish within 10 seconds after being exposed to a flame in a vertical burn test, and they do not drip flaming particles that ignite a cotton ball placed below the material sample. This is the most stringent of the UL 94 vertical burn classifications.

### A. Polyurea

The cover includes a polyurea. Polyurea is a class of synthetic thermosetting polymer that results from a reaction between an isocyanate (e.g., diisocyanate or polyisocyanate) with a compound containing amine groups (e.g., polyamine). As such, the polyurea can be derived from two components, one being an isocyanate and one being an amine. Depending on the isocyanate and/or the amine being used, the polyurea can have varied structure. For example, the polyurea can include aromatic groups, can be aliphatic, or a combination thereof.

The isocyanate includes an isocyanate group (—N═C═O). Example isocyanates include, but are not limited to, an aliphatic diisocyanate, such as 1,4-diisocyanatobutane, 1,6-diisocyanatohexane (HDI), 1,12-diisocyanatododecane, 2-methyl-1,5-diisocyanatopentane, or an aliphatic polyisocyanate; a cycloaliphatic diisocyanate such as methylenedicyclohexylene-4,4′-diisocyanate, 3-isocyanatomethyl-3,5,5-trimethylcyclohexyl isocyanate (isophorone diisocyanate, IPDI), 2,2,4-trimethylhexyl diisocyanate, or cyclohexylene-1,4-diisocyanate; an aromatic-aliphatic diisocyanate such as m-xylylene diisocyanate or tetramethyl-m-xylylene diisocyanate; and an aromatic diisocyanate, such as 2,6-toluene diisocyanate (TDI), 1,3- and 1,4-bis(2-isocyanatoprop-2-yl)benzene (TMXDI), 2,5-toluene diisocyanate, 2,4-toluene diisocyanate, m-phenylene diisocyanate, p-phenylene diisocyanate, methylene bis(o-chlorophenyl diisocyanate), methylenediphenylene 4,4′-diisocyanate, polycarbodiimide-modified methylenediphenylene diisocyanate, (4,4′-diisocyanato-3,3′,5,5′-tetraethyl) diphenylmethane, 4,4′-diisocyanato-3,3′-dimethoxybiphenyl(o-dianisidine diisocyanate), 5-chloro-2,4-toluene diisocyanate, or 1-chloromethyl-2,4-diisocyanato benzene. The isocyanate may also include mixtures of different isocyanates.

The amine includes an amino group (—NH₂). The amine (e.g., polyamine) can be aliphatic or aromatic. Example amines include, but are not limited to, ethylene diamine, 1,2- and 1,3-diaminopropane, 1,4-diaminobutane, 1,6-diaminohexane, isophorone diamine, isomer mixture of 2,2,4- and 2,4,4-trimethyl hexamethylene diamine, 2-methyl pentamethylene diamine, diethylene triamine, 1,3- and 1,4-xylene diamine, α,α,α′,α′-tetramethyl-1,3- and -1,4-xylylene diamine, and 4,4-diaminodicyclohexyl methane. Other example diamines include, but are not limited to, hydrazine, hydrazine hydrate and substituted hydrazines, such as N-methyl hydrazine, N,N′-dimethyl hydrazine and homologues thereof. The amine may also include mixtures of different amines.

The main product of the chemical reaction between an isocyanate and an amine is a urea linkage

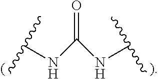 [SMILES: *NC(=O)N*]

The urea linkage can have advantageous hydrolytic stability. This property makes polyurea a useful polymer for wildlife mitigation covers in high-voltage applications. Additionally, polyurea has good mechanical properties (e.g., tensile strength, compression set, tear resistance, and impact resistance) compared to other materials that are used for similar applications.

The polyurea can also include other components to modify the properties of the polyurea. For example, the polyurea can include nonreactive additives such as fillers, pigments, stabilizers, plasticizers, organic tackifiers, antioxidants, compatibilizers, and the like.

The cover can include the polyurea in a varying amount. For example, the cover can include the polyurea at about 50 wt % to about 90 wt %, such as about 55 wt % to about 85 wt %, about 60 wt % to about 80 wt %, about 65 wt % to about 75 wt %, about 50 wt % to about 75 wt %, about 50 wt % to about 70 wt %, about 70 wt % to about 90 wt %, or about 75 wt % to about 90 wt %. In some embodiments, the cover includes the polyurea at no less than 50 wt %, no less than 55 wt %, no less than 60 wt %, no less than 65 wt %, no less than 70 wt %, no less than 75 wt %, or no less than 80 wt %. In some embodiments, the cover includes the polyurea at no more than 90 wt %, no more than 85 wt %, no more than 80 wt %, no more than 75 wt %, no more than 70 wt %, no more than 65 wt %, or no more than 60 wt %. The foregoing percentages in reference to the polyurea denote percentage by weight of the cover.

### B. Silicone

The cover includes a silicone. Although polyurea possesses attractive properties, it can exhibit poor UV stability and electric tracking resistance compared to other materials, such as silicone. Silicone can be used in the high-voltage industry and can have superior UV stability, hydrophobicity and tracking resistance compared to polyurea. Covers including a blend of the two materials, and optional functional fillers, can have improved stability and performance, which can minimize wildlife interruptions and increase reliability of power distribution.

Generally, the basic structure of silicone can include silicon and oxygen atoms, with organic groups attached to the silicon atoms. Example organic groups include, but are not limited to, alkyl, alkenyl, and cyclic groups (e.g., aryl). In some embodiments, the silicone includes a liquid siloxane having organic side chains. In some embodiments, the silicone includes polydimethylsiloxane (PDMS) (e.g., PDMS oil), hexamethyldisiloxane, cyclosiloxane (e.g., octamethylcyclotetrasiloxane (D4), decamethylcyclopentasiloxane (D5), and dodecamethylcyclohexasiloxane (D6)), or a combination thereof. In some embodiments, the silicone includes PDMS, hexamethyldisiloxane, or cyclosiloxane. In some embodiments, the silicone includes PDMS. In some embodiments, the silicone is PDMS.

The cover can include the silicone in a varying amount. For example, the cover can include the silicone at about 1 wt % to about 10 wt %, such as about 1.5 wt % to about 9.5 wt %, about 2 wt % to about 9 wt %, about 2.5 wt % to about 8.5 wt %, about 3 wt % to about 8 wt %, about 3.5 wt % to about 7.5 wt %, about 1 wt % to about 6 wt %, about 1 wt % to about 5 wt %, about 1 wt % to about 4 wt %, about 4 wt % to about 10 wt %, about 5 wt % to about 10 wt %, or about 6 wt % to about 10 wt %. In some embodiments, the cover includes the silicone at no less than 1 wt %, no less than 1.5 wt %, no less than 2 wt %, no less than 2.5 wt %, no less than 3 wt %, no less than 3.5 wt %, no less than 4 wt %, no less than 4.5 wt %, or no less than 5 wt %. In some embodiments, the cover includes the silicone at no more than 10 wt %, no more than 9.5 wt %, no more than 9 wt %, no more than 8.5 wt %, no more than 8 wt %, no more than 7.5 wt %, no more than 7 wt %, no more than 6.5 wt %, no more than 6 wt %, no more than 5.5 wt %, or no more than 5 wt %. The foregoing percentages in reference to the silicone denote percentage by weight of the cover.

### C. Functional Fillers

Different functional fillers can be included in the cover to provide added functionality and/or aid processing. For example, the cover can be reinforced with functional fillers to enhance some of the cover's functionalities (e.g., UV resistance, chemical stability, flame retardancy, etc.). Example functional fillers include, but are not limited to, a flame retardant (e.g., alumina trihydrate), a chemical stabilizer, a UV protectant (e.g., tinuvin), a heat stabilizer (e.g., magnesium hydrate), a compatibilizer, an adhesion promoter (e.g., silica), and a plasticizer. In some embodiments, the functional filler is selected from the group consisting of a flame retardant, a chemical stabilizer, a UV protectant, a heat stabilizer, a compatibilizer, an adhesion promotor, a plasticizer, and a combination thereof. In some embodiments, the functional filler includes alumina trihydrate (ATH), magnesium hydrate (MDH), silica, tinuvin, or a combination thereof. In some embodiments, the functional filler is selected from the group consisting of ATH, MDH, silica, tinuvin, and a combination thereof. In some embodiments, the functional filler includes alumina trihydrate, tinuvin, or a combination thereof.

The cover can include the functional filler in a varying amount. For example, the cover can include the functional filler at about 10 wt % to about 60 wt %, such as about 12 wt % to about 50 wt %, about 15 wt % to about 45 wt %, about 20 wt % to about 40 wt %, about 10 wt % to about 40 wt %, about 10 wt % to about 30 wt %, about 10 wt % to about 25 wt %, about 25 wt % to about 60 wt %, about 30 wt % to about 60 wt %, or about 40 wt % to about 60 wt %. In some embodiments, the cover includes the functional filler at no less than 10 wt %, no less than 11 wt %, no less than 12 wt %, no less than 13 wt %, no less than 14 wt %, no less than 15 wt %, no less than 20 wt %, or no less than 25 wt %. In some embodiments, the cover includes the functional filler at no more than 60 wt %, no more than 55 wt %, no more than 50 wt %, no more than 45 wt %, no more than 40 wt %, no more than 35 wt %, no more than 30 wt %, no more than 25 wt %, no more than 20 wt %, or no more than 15 wt %. In some embodiments, the cover includes more functional filler than silicone as measured by weight percentage. The foregoing percentages in reference to the functional filler denote percentage by weight of the cover.

### D. Example Embodiments

In some embodiments, the cover includes a polyurea and a silicone, wherein the cover has a dielectric strength of at least 450 V/mil as measured by ASTM D149, an inclined plane tracking resistance of at least 3 kV as measured by ASTM D2303, or a combination thereof.

In some embodiments, the cover includes, by weight: about 50% to about 90% of a polyurea; about 1% to about 10 wt % of a silicone; and about 10% to about 60% of a functional filler.

In some embodiments, the cover includes, by weight: about 50% to about 90% of a polyurea; about 1% to about 10 wt % of a silicone; and about 10% to about 60% of a functional filler, wherein the cover has a dielectric strength of at least 450 V/mil as measured by ASTM D149, an inclined plane tracking resistance of at least 3 kV as measured by ASTM D2303, or a combination thereof.

In some embodiments, the cover includes, by weight: about 50% to about 90% of a polyurea; about 1% to about 10 wt % of a silicone, wherein the silicone includes PDMS; and about 10% to about 60% of a functional filler.

In some embodiments, the cover includes, by weight: about 65% to about 85% of a polyurea; about 1% to about 6 wt % silicone; and about 10% to about 40% of a functional filler.

In some embodiments, the cover includes, by weight: about 70% of a polyurea, wherein the polyurea is derived from equal parts of an amine and an isocyanate; about 5% polydimethylsiloxane (PDMS) oil; about 9.5% alumina trihydrate; and about 0.5% tinuvin.

In some embodiments, the cover consists essentially of a polyurea and a silicone.

In some embodiments, the cover consists essentially of a polyurea, a silicone, and a functional filler.

### 3. METHODS OF MAKING COVERS

Further disclosed herein are methods of making the disclosed covers for protecting high-voltage components from wildlife. The method can include mixing a silicone with an amine, an isocyanate, or both. In such embodiments, the silicone is mixed with the components that make the polyurea, rather than the polyurea itself. The polyurea can then be polymerized in the presence of the silicone. Alternatively, the method can include mixing and/or blending a polyurea and a silicone to form a mixture.

The method can include spraying techniques, such as those traditionally used in polyurea spraying applications. For example, the method can include spraying the silicone, the amine, and the isocyanate, or the mixture of silicone and polyurea, onto a mold to provide the cover. The mixture can be sprayed onto a mold (e.g., rigid mold) and dried to provide the cover. The mold can resemble the intended high-voltage component to be protected, such that the cover will securely attach and protect the high-voltage component. In addition, the cover can be post-processed and/or customized via, e.g., a grinding station, to provide the final shape of the cover.

Because the cover can be made by spraying techniques, the cover does not require injection molding. Accordingly, in some embodiments, the method does not include injection molding the cover.

The description above regarding the high-voltage component, the cover, the polyurea, the silicone, and the functional fillers can also be applied to the methods of making the covers.

### 4. HIGH-VOLTAGE ASSEMBLIES

Also disclosed herein are high-voltage assemblies that include the disclosed cover. The high-voltage assembly can include a component capable of operating in a high-voltage environment; and a cover as disclosed herein at least partially enclosing the component. The description above regarding the high-voltage component, the cover, the polyurea, the silicone, and the functional fillers can also be applied to the high-voltage assembly. For the purposes of brevity, they will not be repeated here.

The disclosed technology has multiple aspects, illustrated by the following non-limiting examples.

### 5. EXAMPLES

### Example 1

### Example Cover for Wildlife Mitigation

A high-performance, rapid-curing polyurea material that provides high strength and durability is used. The material includes 2 parts: amine resin and isocyanate (ISO). The materials are heated and pressurized through a proportioner and both parts mix as it's sprayed though the mixing head of the spray gun. Production technicians spray material onto the surface of an aluminum mold until the desired thickness is obtained. Silicone can be blended with the amine resin and/or ISO and sprayed in conjunction or can be sprayed separately.

After final quality checks, the cured material is cut off the mold and is ready for further customization. The part goes through a grinding station where edges are refined and then the part is washed for final quality control (QC) and assembly checks. The parts are boxed in a fashion that best facilitates installation at site. Installation instructions are provided to the customer indicating where to install parts. Parts are held in place using push fasteners which allow for easy removal and reinstall during equipment inspections and maintenance operations. The customized cover is designed to prevent or minimize power outages by reducing wildlife contact risk.

### Example Cover Composition:

about 70% by weight polyurea, which is derived from equal parts isocyanate and polyamine;
about 5% by weight polydimethylsiloxane (PDMS) oil;
about 9.5% by weight ATH; and
about 0.5% by weight tinuvin.

### Example 2

### Example Cover v. Polyurea Cover

An example cover was made via a spray process as described in Example 1. The cover included 2 wt % silicone. The cover was characterized and compared to a polyurea (PUR) cover lacking silicone. The properties of these covers were compared and are shown below in Table 1.

TABLE 1
Comparison of Example Cover v. PUR Cover

| | | | PUR + 2 wt % | |
|---|---|---|---|---|
| | PUR | | Silicone | |
| Tracking (ASTM D2303) | 2.5 | kV | 3.25 | kV |
| Tensile Strength (ASTM D412) | ~2,000 | PSI | >2,000 | PSI |
| UV Stability (ASTM 4329) | ~1,000 | h | >1,000 | h |

| | | |
|---|---|---|
| Flammability (UL-94) | V-0 | V-0 |

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, components, compositions, formulations, or methods of use of the technology, may be made without departing from the spirit and scope thereof.

For reasons of completeness, the following Embodiments are provided.

Clause 1. A cover for protecting a high-voltage component from wildlife, the cover comprising: a polyurea; and a silicone.

Clause 2. The cover of clause 1, wherein the cover comprises the polyurea at about 50 weight percent (wt %) to about 90 wt % by weight of the cover.

Clause 3. The cover of clause 1 or 2, wherein the polyurea is derived from equal parts of an amine and an isocyanate.

Clause 4. The cover of any one of clauses 1-3, wherein the cover comprises the silicone at about 1 wt % to about 10 wt % by weight of the cover.

Clause 5. The cover of any one of clauses 1-4, wherein the silicone comprises polydimethylsiloxane (PDMS), hexamethyldisiloxane, cyclosiloxane, or a combination thereof.

Clause 6. The cover of clause 5, wherein the silicone comprises PDMS.

Clause 7. The cover of any one of clauses 1-6, wherein the cover comprises a functional filler selected from the group consisting of a flame retardant, a chemical stabilizer, an ultraviolet (UV) protectant, a heat stabilizer, a compatibilizer, an adhesion promotor, a plasticizer, and a combination thereof.

Clause 8. The cover of clause 7, wherein the functional filler is selected from the group consisting of alumina trihydrate, magnesium hydrate, silica, tinuvin, and a combination thereof.

Clause 9. The cover of clause 7 or 8, wherein the functional filler comprises alumina trihydrate, tinuvin, or a combination thereof.

Clause 10. The cover of any one of clauses 7-9, wherein the cover comprises the functional filler at about 10 wt % to about 60 wt % by weight of the cover.

Clause 11. The cover of any one of clauses 1-10, having a dielectric strength of at least 450 V/mil as measured by ASTM D149.

Clause 12. The cover of any one of clauses 1-11, having an inclined plane tracking resistance of at least 3 kV as measured by ASTM D2303.

Clause 13. The cover of any one of clauses 1-12, having one of the following: a tensile strength of at least 13.8 MPa as measured by ASTM D412, an UV stability of at least 1,000 hours as measured by ASTM 4329, a UL-94 flammability of V-0, or a combination thereof.

Clause 14. The cover of any one of clauses 1-13, being molded to the shape of the high-voltage component.

Clause 15. The cover of any one of clauses 1-14, wherein the high-voltage component is rated for voltage up to 70 kV.

Clause 16. The cover of any one of clauses 1-15, wherein the high-voltage component is an energized component in an electrical power distribution system.

Clause 17. The cover of any one of clauses 1-16, wherein the high-voltage component is an arrester, a transmission and distributor insulator, a polymer cut-out, a fusing, a bushing, or an interrupter.

Clause 18. A cover for protecting a high-voltage component from wildlife, the cover comprising, by weight: about 70% polyurea, wherein the polyurea is derived from equal parts of an amine and an isocyanate; about 5% polydimethylsiloxane (PDMS) oil; about 9.5% alumina trihydrate; and about 0.5% tinuvin.

Clause 19. A high-voltage assembly comprising: a component capable of operating in a high-voltage environment; and a cover at least partially enclosing the component, the cover comprising a polyurea, and a silicone.

Clause 20. A method of making a cover for protecting a high-voltage component from wildlife, the method comprising: mixing a silicone with an amine, an isocyanate, or both; and spraying the silicone, the amine, and the isocyanate onto a mold to provide the cover.

What is claimed is:

1. A cover for protecting a high-voltage component from wildlife, the cover comprising:
a polyurea; and
a silicone.

2. The cover of claim 1, wherein the cover comprises the polyurea at about 50 weight percent (wt %) to about 90 wt % by weight of the cover.

3. The cover of claim 1, wherein the polyurea is derived from equal parts of an amine and an isocyanate.

4. The cover of claim 1, wherein the cover comprises the silicone at about 1 wt % to about 10 wt % by weight of the cover.

5. The cover of claim 1, wherein the silicone comprises polydimethylsiloxane (PDMS), hexamethyldisiloxane, cyclosiloxane, or a combination thereof.

6. The cover of claim 5, wherein the silicone comprises PDMS.

7. The cover of claim 1, wherein the cover comprises a functional filler selected from the group consisting of a flame retardant, a chemical stabilizer, an ultraviolet (UV) protectant, a heat stabilizer, a compatibilizer, an adhesion promotor, a plasticizer, and a combination thereof.

8. The cover of claim 7, wherein the functional filler is selected from the group consisting of alumina trihydrate, magnesium hydrate, silica, tinuvin, and a combination thereof.

9. The cover of claim 7, wherein the functional filler comprises alumina trihydrate, tinuvin, or a combination thereof.

10. The cover of claim 7, wherein the cover comprises the functional filler at about 10 wt % to about 60 wt % by weight of the cover.

11. The cover of claim 1, having a dielectric strength of at least 450 V/mil as measured by ASTM D149.

12. The cover of claim 1, having an inclined plane tracking resistance of at least 3 kV as measured by ASTM D2303.

13. The cover of claim 1, having one of the following:
a tensile strength of at least 13.8 MPa as measured by ASTM D412,
an UV stability of at least 1,000 hours as measured by ASTM 4329,
a UL-94 flammability of V-0, or
a combination thereof.

14. The cover of claim 1, being molded to the shape of the high-voltage component.

15. The cover of claim 1, wherein the high-voltage component is rated for voltage up to 70 kV.

16. The cover of claim 1, wherein the high-voltage component is an energized component in an electrical power distribution system.

17. The cover of claim 1, wherein the high-voltage component is an arrester, a transmission and distributor insulator, a polymer cut-out, a fusing, a bushing, or an interrupter.

18. A cover for protecting a high-voltage component from wildlife, the cover comprising, by weight:
about 70% polyurea, wherein the polyurea is derived from equal parts of an amine and an isocyanate;
about 5% polydimethylsiloxane (PDMS) oil;
about 9.5% alumina trihydrate; and
about 0.5% tinuvin.

19. A high-voltage assembly comprising:
a component capable of operating in a high-voltage environment; and
a cover at least partially enclosing the component, the cover comprising
a polyurea, and
a silicone.

20. A method of making a cover for protecting a high-voltage component from wildlife, the method comprising:
mixing a silicone with an amine, an isocyanate, or both; and
spraying the silicone, the amine, and the isocyanate onto a mold to provide the cover.
